(19) United States
(12) Patent Application Publication
(10) Pub. No.: US 2015/0131012 A1
(43) Pub. Date: May 14, 2015

(54) DISPLAY DEVICE AND LIQUID CRYSTAL LENS PANEL DEVICE FOR THE SAME

(71) Applicant: Samsung Display Co., Ltd., Yongin-City (KR)

(72) Inventor: Hyeon Yong JANG, Hwaseong-si (KR)

(73) Assignee: Samsung Display Co., Ltd., Yongin-City (KR)

(21) Appl. No.: 14/249,896

(22) Filed: Apr. 10, 2014

(30) Foreign Application Priority Data
Nov. 11, 2013 (KR) 10-2013-0136380

(51) Int. Cl. G02F 1/133

(52) U.S. Cl. CPC G02F 1/13306
USPC 349/15; 349/33

(57) ABSTRACT

A display device includes: a display panel configured to display an image; a liquid crystal lens panel configured to operate in a 2D mode for recognizing the image as a 2D image and operate in a 3D mode for recognizing the image as a 3D image; and a power supply configured to supply power to the liquid crystal lens panel. The liquid crystal lens panel includes a second electrode layer configured to have a common voltage applied, a first electrode layer facing the second electrode layer and including a plurality of linear electrodes, a first bus line to which some of the plurality of linear electrodes are connected, and a second bus line to which remaining linear electrodes are connected. The power supply is configured to invert a first driving voltage output to the first bus line and a second driving voltage output to the second bus line at different times, and then output them.

### CROSS-REFERENCE TO RELATED APPLICATION

This application claims priority to and the benefit of Korean Patent Application No. 10-2013-0136380 filed in the Korean intellectual Property Office on Nov. 11, 2013, the entire contents of which are incorporated herein by reference.

### BACKGROUND

(a) Field

Embodiments relate to a display device and a liquid crystal lens panel for the display device.

(b) Description of the Related Art

Recently, with the development of display device technology, a 3-dimensional (3D) image display device has drawn attention, and various methods of displaying the 3D image have been researched.

One of the most general methods used in realization of a 3D image display is a method of using binocular disparity. The method of using binocular disparity displays an image reaching the left eye and an image reaching the right eye in the same display device, and inputs the two images to the left eye and the right eye, respectively. That is, the images viewed at different angles with both eyes are input and thus an absorber may perceive a 3D effect.

In this case, a method of inputting the images to the left eye and the right eye of the observer includes a method of using a barrier, a method of using a lenticular lens which is a kind of cylindrical lens, and the like.

In the 3D image display device using the barrier, a slit is formed in the barrier and thus the image from the display device is divided into a left eye image and a right eye image through the slit to input the divided image to the left eye and the right eye of the observer respectively.

The 3D image display device using the lens displays the left eye image and the right eye image, respectively, and divides the image from the 3D image display device into the left eye image and the right eye image by changing a light path using the lens.

A 2D/3D image display device that can display both of a planar image and a stereoscopic image has been developed, and for this, a liquid crystal lens panel that can switch a planar image and a stereoscopic image has been developed. The liquid crystal lens panel may be attached to the display device, and the liquid crystal lens panel is increased in size as the size of the display device is increased. As the liquid crystal lens panel is increased in size, current supply capability and a response speed characteristic of a power source for driving the liquid crystal lens panel should be improved. When an insufficient amount of current is supplied to the liquid crystal lens panel from the power source, the shape of a lens formed in the liquid crystal lens panel is temporarily changed and thus a display quality of a 3D image may be deteriorated.

However, there is a limit in improvement of the current supply capability and the response speed characteristic, and a manufacturing expense for a 2D/3D display device may be increased.

The above information disclosed in this Background section is only for enhancement of understanding of the background of the disclosure and therefore it may contain information that does not form the prior art that is already known in this country to a person of ordinary skill in the art.

### SUMMARY

Embodiments have been made in an effort to provide a display device that can supply a sufficient amount of current to a liquid crystal lens panel, and a liquid crystal lens panel device for the display device.

A display device according to an exemplary embodiment includes a display panel configured to display an image; a liquid crystal lens panel configured to operate in a 2D mode for recognizing the image as a 2D image and operate in a 3D mode for recognizing the image as a 3D image; and a power supply configured to supply power to the liquid crystal lens panel. The liquid crystal lens panel includes a second electrode layer configured to have a common voltage applied, a first electrode layer facing the second electrode layer and including a plurality of linear electrodes, a first bus line to which some of the plurality of linear electrodes are connected, and a second bus line to which remaining linear electrodes are connected. The power supply is configured to invert a first driving voltage output to the first bus line and a second driving voltage output to the second bus line at different times, and then output them.

The power supply includes a first driving IC, a second driving IC, a DC power source, a DC-DC converter, and a lens controller. The first driving IC is connected to linear electrodes connected to the first bus line among the plurality of linear electrodes. The second driving IC is connected to linear electrodes connected to the second bus line among the plurality of linear electrodes. The DC power source is configured to generate a DC power voltage. The DC-DC converter is configured to convert the DC power voltage to a predetermined DC voltage and supply the predetermined DC voltage to the first driving IC and the second driving IC. The lens controller is configured to apply a first polarity inversion signal to the first driving IC and apply a second polarity inversion signal to the second driving IC.

The first driving IC is configured to invert a first driving voltage applied to linear electrodes connected to the first bus line by the first polarity inversion signal and then output it. The second driving IC is configured to invert a second driving voltage applied to linear electrodes connected to the second bus line by the second polarity inversion signal and then output it.

The second polarity inversion signal may be delayed by half the time that the first polarity inversion signal is applied as a logic high level voltage.

The first driving voltage and the second driving voltage may be inverted at different times and then output.

The first bus line and the second bus line may be electrically separated from each ether.

The lens controller may be configured to receive a lens control signal, stop operation of the first driving IC and the second driving IC when the lens control signal instructs the 2D mode, and activate operation of the first driving IC and the second driving IC when the lens control signal instructs the 3D mode.

The lens controller may be configured to stop operation of the DC-DC converter when the lens control signal instructs the 2D mode, and may be configured to activate the DC-DC converter when the lens control signal instructs the 3D mode.

The liquid crystal lens panel may further include a third bus line to which some of the remaining linear electrodes are connected, and the power supply may further include a third driving IC connected to the linear electrodes that are connected to the third bus line among the plurality of linear electrodes.

The lens controller may be configured to apply a third polarity inversion signal to the third driving IC, and the third driving IC may be configured to convert a third driving voltage applied to linear electrodes connected to the third bus line by the third polarity inversion signal and then output the inverted third driving voltage.

The first driving voltage, the second driving voltage, and the third driving voltage may be inverted at different times and then output.

A liquid crystal lens panel device according to another exemplary embodiment includes a first electrode layer, a second electrode layer, a first bus line, a second bus line, a first driving IC, a second driving IC, and a lens controller. The second electrode layer is configured to have a common voltage applied. The first electrode layer faces the second electrode layer and includes a plurality of linear electrodes. The first bus line is connected to some of the plurality of linear electrodes. The second bus line is connected to some other of the plurality of linear electrodes. The first driving IC is connected to the linear electrodes connected to the first bus line among the plurality of linear electrodes. The second driving IC is connected to the linear electrodes connected to the second bus line among the plurality of linear electrodes. The lens controller is configured to apply a first polarity inversion signal to the first driving IC and apply a second polarity inversion signal to the second driving IC.

The liquid crystal lens panel device may further include a DC power source configured to generate a DC power voltage, and a DC-DC converter configured to convert the DC power voltage to a predetermined DC voltage and supply the predetermined DC voltage to the first driving IC and the second driving IC.

The first driving IC may he configured to invert a first driving voltage applied to the linear electrodes connected to the first bus line by the first polarity inversion signal and may then be configured to output the inverted first driving voltage. The second driving IC may be configured to invert a second driving voltage applied to the linear electrodes connected to the second bus line by the second polarity inversion signal and may then be configured to output the inverted second driving voltage.

The second polarity inversion signal may be delayed by half the time that the first polarity inversion signal is applied as a logic high level voltage and is then output.

The first driving voltage and the second driving voltage may be inverted at different times and then output.

The first bus line and the second bus line may be electrically separated from each other.

The liquid crystal lens panel may further include a third bus line connected to some of the remaining linear electrodes, and the power supply may further include a third driving IC connected to the linear electrodes connected to the third bus line among the plurality of linear electrodes.

The lens controller may be configured to apply a third polarity inversion signal to the third driving IC, and the third driving IC may be configured to invert a third driving voltage applied to the linear electrodes connected to the third bus line by the third polarity inversion signal and may then be configured to output the inverted third driving voltage.

The first driving voltage, the second driving voltage, and the third driving voltage may be inverted at different times and then output.

Accordingly to the inventive concept, a sufficient amount of current can be supplied to a liquid crystal lens panel without improving capability of a power supply supplying power to the liquid crystal lens panel and a response speed characteristic, and deterioration of display quality of a 3D image due to supply of an insufficient amount of current to the liquid crystal lens panel can be prevented.

### BRIEF DESCRIPTION OF THE DRAWINGS

FIG. 1 shows a schematic structure of a display device and a method for forming a 2D image according to an exemplary embodiment.

FIG. 2 shows a schematic structure of the display device and a method for forming a 3D image according to the exemplary embodiment.

FIG. 3 is a perspective view of a liquid crystal lens panel included in the display device according to the exemplary embodiment.

FIG. 4 is a cross-sectional view of the liquid crystal lens of FIG. 3, taken along the line IV-IV.

FIG. 5 shows one example of a top plan view of an xy plane of the liquid crystal lens panel of FIG. 3.

FIG. 6 shows another example of the top plan view of the xy plane of the liquid crystal panel of FIG. 3.

FIG. 7 is a graph illustrating a phase delay variation according to a location of a phase modulation type of Fresnel zone plate.

FIG. 8 is a cross-sectional view partially illustrating a unit element in the liquid crystal lens panel according to the exemplary embodiment.

FIG. 9 shows a phase delay formed according to a location in the liquid crystal lens panel of FIG. 8.

FIG. 10 shows an electrode and an external power supply of the liquid crystal panel according to the exemplary embodiment.

FIG. 11 shows a configuration of an electrode connection in the liquid crystal lens panel or FIG. 10.

FIG. 12 is a timing diagram illustrating a polarity inversion signal applied to the liquid crystal lens panel of FIG. 10.

FIG. 13 is a graph illustrating an example of a driving voltage applied to a conventional liquid crystal lens panel.

FIG. 14 is a graph illustrating power consumed in the conventional liquid crystal lens panel.

FIG. 16 is a graph illustrating an example of a driving voltage applied to an electrode of a liquid crystal lens panel according to the exemplary embodiment.

FIG. 18 is a graph illustrating an example of power consumed in the liquid crystal lens panel according to the exemplary embodiment.

FIG. 17 shows a configuration of electrode connection in a liquid crystal lens panel according to another exemplary embodiment.

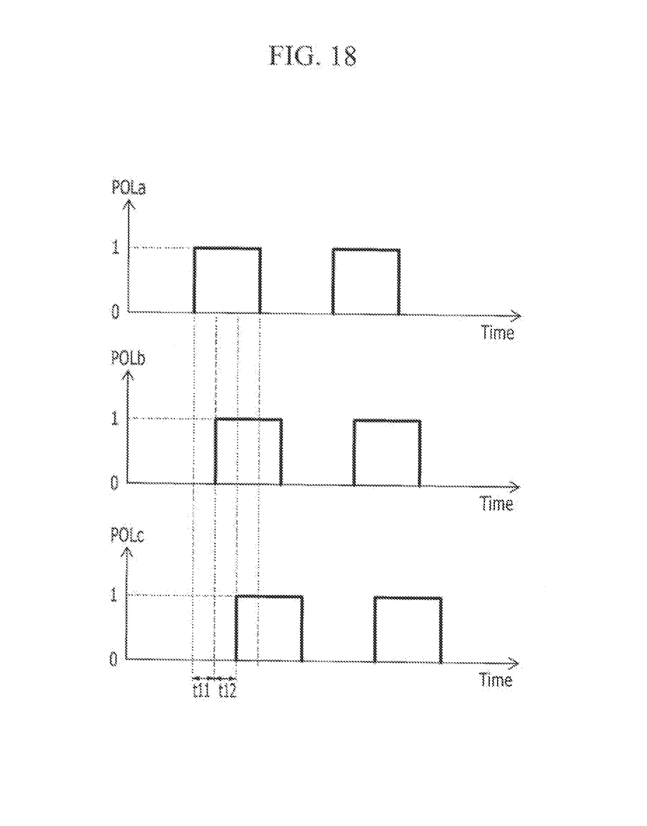

FIG. 18 is a timing diagram of a polarity inversion signal applied to the liquid crystal lens panel of FIG. 17.

### DETAILED DESCRIPTION

Embodiments will be described more fully hereinafter with reference to the accompanying drawings, in which exemplary embodiments are shown. As those skilled in the art would realize, the described embodiments may be modified in various different ways, all without departing from the spirit or scope of the inventive concept.

Further, in exemplary embodiments, since like reference numerals designate like elements having the same configuration, a first exemplary embodiment is representatively described, and in other exemplary embodiments, only configurations different from the first exemplary embodiment will be described.

The drawings and description are to be regarded as illustrative in nature and not restrictive, and like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present.

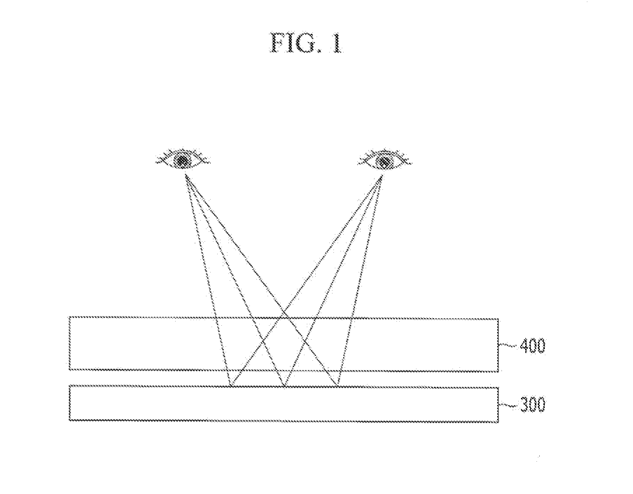

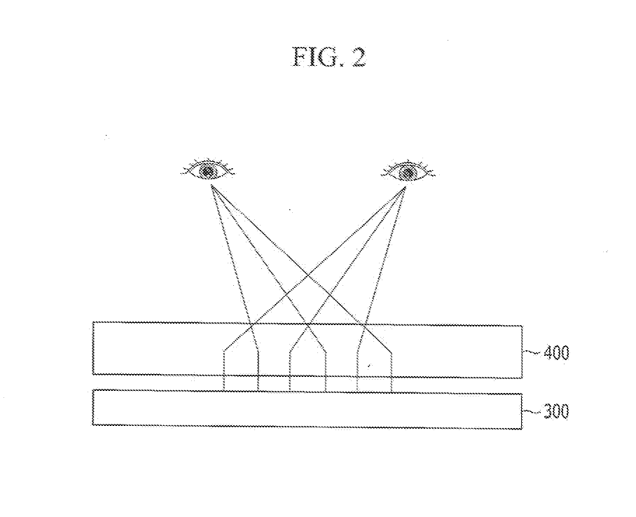

FIG. 1 shows a schematic structure of a display device and a method for forming a 2D image according to an exemplary embodiment. FIG. 2 shows a schematic structure of the display device and a method for forming a 3D image according to the exemplary embodiment.

Referring to FIG. 1 and FIG. 2, a display device includes a display panel 300, a liquid crystal lens panel 400 located in front of a plane where an image is displayed, and a power supply (not shown) supplying power to the liquid crystal lens panel 400. The power supply unit may be included in the liquid crystal lens panel 400. Both of the display panel 300 and the liquid crystal lens panel 400 may be operated in a 2D mode or a 3D mode.

The display panel 300 may be realized as various display panels such as a plasma display device, a liquid crystal display, an organic light emitting display, and the like. The display panel 300 includes a plurality of pixels PX arranged in a matrix format and displaying an image. The display panel 300 displays only one plane image in the 2D mode, but may display an image that corresponds to various viewing fields such as a right-eye image and a left-eye image by a spatial or temporal division method in the 3D mode. For example, the display panel 300 may alternately display the right-eye image and the left-eye image for each pixel array in the 3D mode.

The liquid crystal lens panel 400 is driven in the 2D mode for realization of an image displayed in the display panel 300 as a 2D image, and is driven in the 3D mode for realization of an image displayed in the display panel 300 as a 3D image. The liquid crystal lens panel 400 transmits the image displayed in the display panel 300 as it is in the 2D mode, and separates the viewing fields of the image of the display panel 300 in the 3D mode. That is, the liquid crystal lens panel 400 operating in the 3D mode focuses a multi-viewpoint image including the left-eye image and the right-eye image displayed on the display panel 300 on a corresponding viewing field for each viewpoint image by using diffraction and refraction of light.

FIG. 1 shows a case that both of the display panel 300 and the liquid crystal lens panel 400 operate in the 2D mode. In the 2D mode, the same image reaches the left eye and the right eye such that a 2D image is recognized.

FIG. 2 shows a case that both of the display panel 300 and the liquid crystal lens panel 400 operate in the 3D mode. The liquid crystal lens panel 400 divides an image of the display panel 300 into the left-eye viewing field and the right-eye viewing field, and refracts the divided image such that a 3D image is recognized.

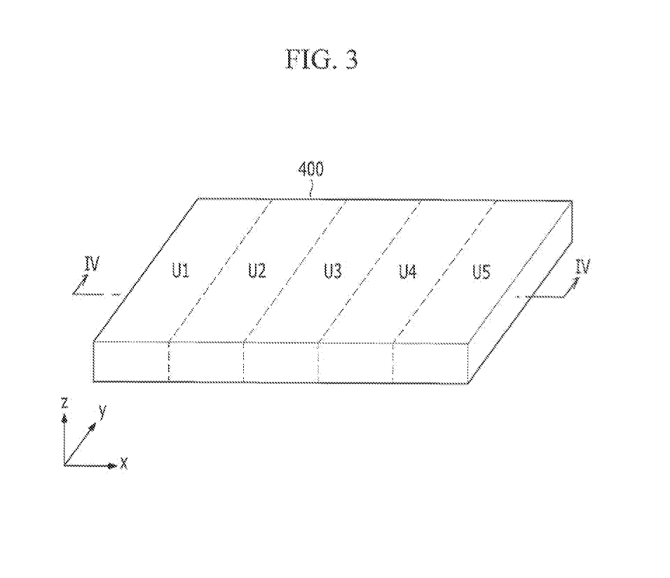

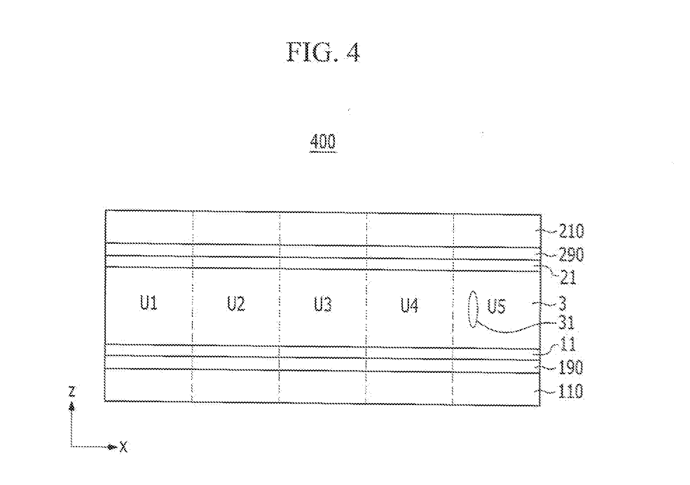

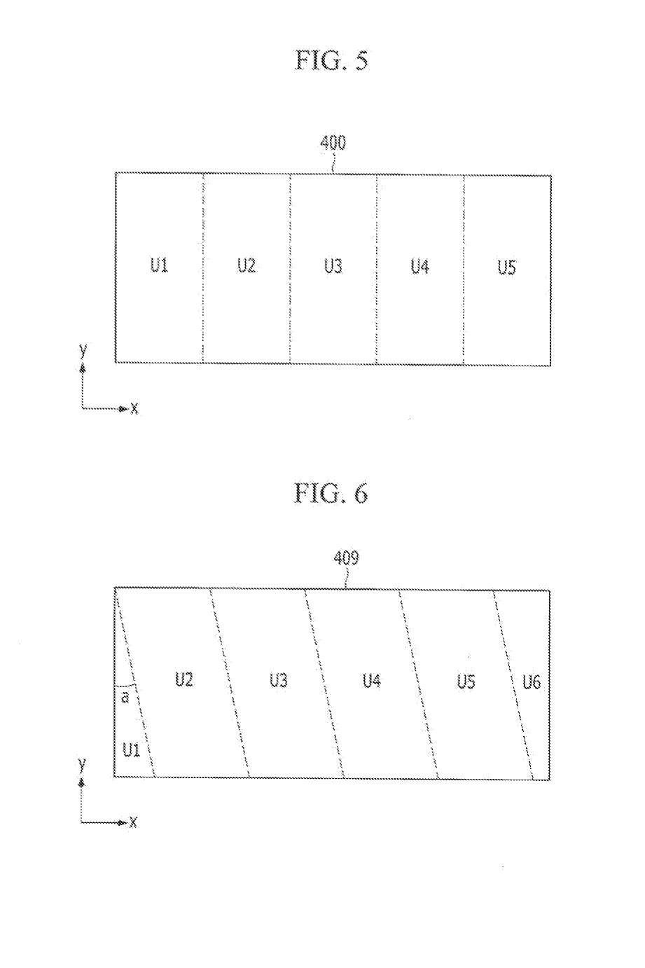

FIG. 3 is a perspective view of the liquid crystal lens panel included in the display device according to the exemplary embodiment. FIG. 4 is a cross-sectional view of the liquid crystal lens panel of FIG. 3, taken along the line IV-IV. FIG. 5 shows an example of a top plan view of the xy plane of the liquid crystal lens panel of FIG. 3.

Referring to FIG. 3 to FIG. 5, the liquid crystal lens panel 400 includes a plurality of unit elements U1 to U5 sequentially located along the x-axis direction. Each unit element covers N viewpoints of the display panel 300 (here, N is a natural number). One viewpoint corresponds to one pixel, For example, one unit element may cover 9 viewpoints. One unit element may function as a single lens.

The liquid crystal lens panel 400 includes first and second substrates 110 and 210 made of an insulating material such as glass, plastic, and the like and disposed facing each other, and a liquid crystal layer 3 provided between the two substrates 110 and 210.

A first electrode layer 190 and a first alignment layer 11 are sequentially arranged on the first substrate 110. A second electrode layer 290 and a second alignment layer 21 are sequentially arranged on the second substrate 210. The first electrode layer 190 and the second electrode layer 290 may be made of a transparent conductive material such as indium tin oxide (ITO) or indium zinc oxide (IZO). The first electrode layer 190 may be patterned with a plurality of linear electrodes. The second electrode layer 290 may be formed as a single plate-shape electrode without having an additional pattern.

In FIG. 5, boundaries between the unit elements U1 to U5 of the liquid crystal lens panel 400 are parallel with the y-axis, but this is not restrictive.

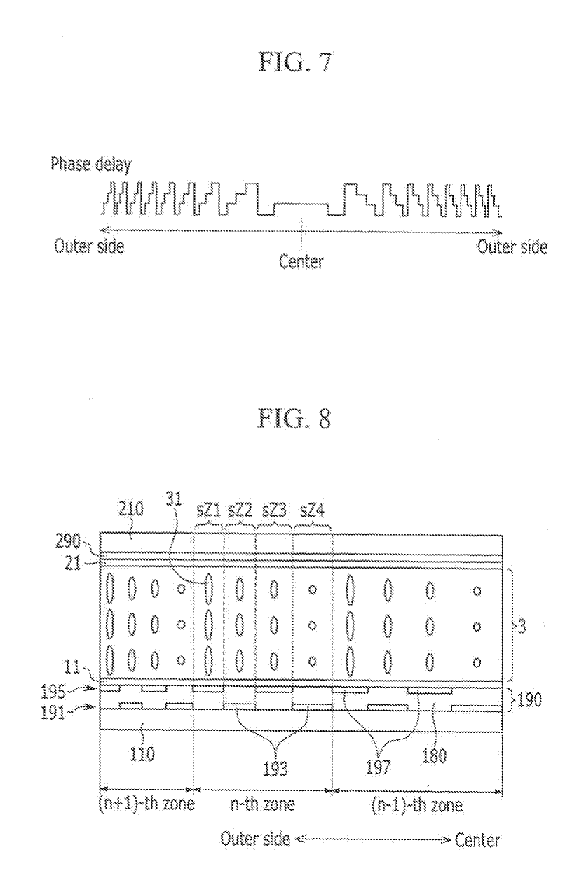

FIG. 6 shows another example of a top plan view of the xy plane of the liquid crystal lens panel of FIG. 3.

Referring to FIG. 6, a liquid crystal lens panel 409 includes a plurality of unit elements U1 to U6, and boundaries between the unit elements U1 to U6 are inclined with an angle a with respect to the y-axis. For example, the angle a may be between 10 degrees to 30 degrees.

Hereinafter, for convenience of description, as shown in FIG. 6, it is assumed that the boundaries between the unit elements U1 to U6 of the liquid crystal lens panel 400 are inclined by the angle a with respect to the y-axis.

Referring back to FIG. 4, the first electrode layer 190 and the second electrode layer 290 generate an electric field in the liquid crystal layer 3 according to an applied voltage to control alignment of liquid crystal molecules 31 of the liquid crystal layer 3. The alignment layers 11 and 21 determine initial alignment of the liquid crystal molecules 31 of the liquid crystal layer 3. The liquid crystal layer 3 may be aligned with various modes such as a horizontal alignment mode, a vertical alignment mode, a twisted nematic (TN) mode, and the like.

The liquid crystal lens panel 400 operates in the 2D mode or the 3D mode according to a voltage applied to the first electrode layer 190 and the second electrode layer 290. When no voltage is applied to the first electrode layer 190 and the second electrode layer 290, the liquid crystal lens panel 400 operates in the 2D mode. When a voltage is applied to the first electrode layer 190 and the second electrode layer 290, the liquid crystal lens panel 400 may operate in the 3D mode. For this purpose, the initial alignment of the liquid crystal molecules 31 may be appropriately adjusted.

When the liquid crystal lens panel 400 operates in the 3D mode, each of the unit elements U1 to U5 of the liquid crystal lens panel 400 functions as a single lens. The initial alignment of the liquid crystal molecules 31 may be set for each of the unit elements U1 to U5 to function as a single lens.

Hereinafter, the liquid crystal lens panel 400 operating in the 3D mode will be described.

The plurality of unit elements U1 to U5 included in the liquid crystal lens panel 400 operating in the 3D mode may be arranged with a constant cycle along a direction of one side of the liquid crystal lens panel 400. Locations of the unit elements U1 to U5 may be fixed or changed according to time in the liquid crystal lens panel 400.

A single unit element may be realized as a Fresnel zone plate. The Fresnel zone plate is a device serving as a lens by using diffraction of light instead of refraction of light by using a plurality of concentric circles which are generally radially arranged like a Fresnel zone, and have a distance that is narrowed toward an outer side from a center thereof.

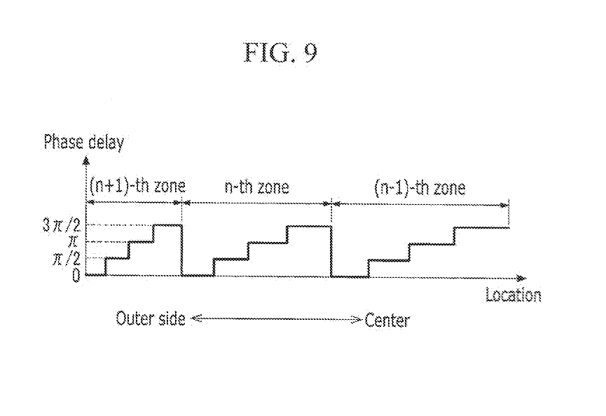

FIG. 7 is a graph illustrating a phase delay change according to a position of a phase modulation type of Fresnol zone plate. Here, each zone of the Fresnel zone plate becomes a region to which a repeated waveform belongs.

Referring to FIG. 7, phase delay in each zone is changed step-by-step. In the zone at the center, the phase delay is changed in two steps, and in the zones except for the center, the phase delay is changed in four steps. However, it is not limited to the number of steps in which the phase delay is changed in each zone.

As in FIG. 7, the Fresnel zone plate in which the phase delay is changed step-by-step in each zone is called a multi-level phase modulation zone plate. The liquid crystal lens panel 400 may refract light to be collected at a focus position through refraction and extinctive and constructive interference of light passing through each zone. As such, a phase delay distribution is formed according to the Fresnel zone plate for each unit element of the liquid crystal lens 400 panel to generate a lens effect.

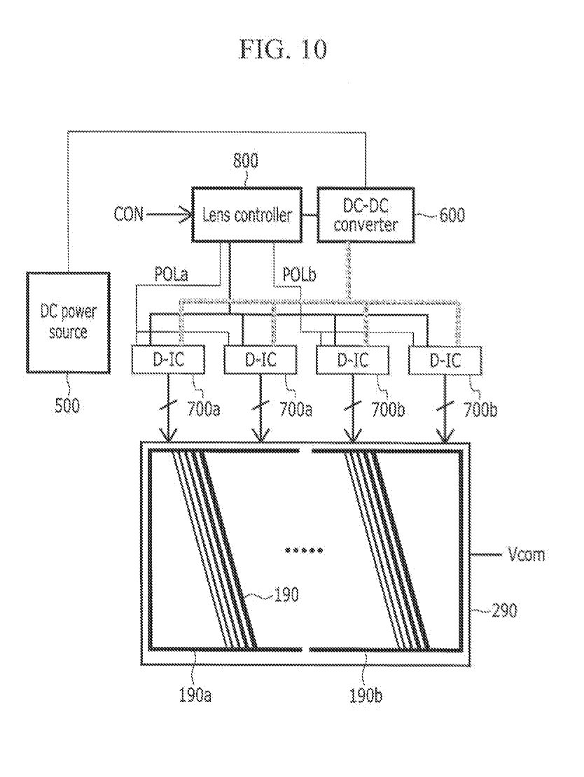

FIG. 8 is a cross-sectional view illustrating a part of a unit element in the liquid crystal lens panel 400 according to the exemplary embodiment. The same constituent elements as in the exemplary embodiment of FIG. 4 are designated by the same reference numerals, and duplicated description is omitted.

Referring to FIG. 8, the liquid crystal lens panel 400 includes a first substrate 110 and a second substrate 210 facing each other, and a liquid crystal layer 3 provided between the two substrates 110 and 210. A first electrode layer 190 and an alignment layer 11 are sequentially formed on the first substrate 110, and a second electrode layer 290 and an alignment layer 21 are sequentially formed on the second substrate 210.

The first electrode layer 190 includes a first linear electrode array 191 including a plurality of first linear electrodes 193, an insulating layer 180 formed on the first linear electrode array 191, and a second linear electrode array 195 formed on the insulating layer 180 and including a plurality of second linear electrodes 197.

The first linear electrode 193 and the second linear electrode 197 may alternately overlap each other with reference to a horizontal direction, or may not overlap each other. In FIG. 8, edges of the first linear electrode 193 and the second linear electrode 197 which are adjacent to each other do not overlap each other, but a part of the edges may slightly overlap each other.

A horizontal width of the first linear electrode 193 and the second linear electrode 197, a distance between the first linear electrodes 193, and a distance between the second linear electrodes 197 are gradually decreased toward the outer side from the center of the unit element, and are gradually decreased toward the outer side from the center in each zone. Two of the first linear electrodes 193 and the second linear electrodes 197 are positioned in each zone of the unit element, such as an (n−1)-th zone, an n-th zone, and an (n+1)-th zone, and a region where the first and second linear electrodes 193 and 197 are positioned in each zone forms one sub-zone sZ1, sZ2, sZ3, or sZ4. In one zone, the sub-zones from the outer side to the center are represented as sZ1, sZ2, sZ3, and sZ4 in sequence. In FIG. 8, one zone includes four sub-zones sZ1, sZ2, sZ3, and sZ4, but the number of sub-zones is not limited thereto. Unlike those illustrated in FIG. 8, the horizontal width of the first linear electrode 193 and the second linear electrode 197 included in one zone may be uniform, and the number of the first and second linear electrodes 193 and 197 included in each zone may be decreased toward the outer side.

In all zones, the horizontal widths of the first linear electrodes 193 and the second linear electrodes 197 may be larger than or equal to a cell gap of the liquid crystal layer 3. However, it is difficult to reduce the cell gap due to a process limit and a liquid crystal refractive index limit.

The insulating layer 180 may be made of an inorganic insulator or an organic insulator, and electrically insulates between the first linear electrode army 191 and the second linear electrode array 195.

The second electrode layer 200 is formed on the entire surface of the second substrate 210 and receives a predetermined voltage such as a common voltage Vcom. The second electrode layer 290 may be made of a transparent conductive material such as ITO, IZO, and the like.

The alignment layers 11 and 21 may be rubbed in a longitudinal direction (i.e., a direction vertical to a surface of the drawing) which is perpendicular to a lateral direction of the first linear electrode 193 and the second linear electrode 197, or a direction forming a predetermined angle with the longitudinal direction. The rubbing directions of the alignment layer 11 on the first substrate 110 and the alignment layer 21 on the second substrate 210 may be opposite to each other.

The liquid crystal molecules 31 of the liquid crystal layer 3 may be initially aligned in a direction which is horizontal with respect to the surfaces of the substrates 110 and 210, but the alignment mode of the liquid crystal layer 3 is not limited thereto and may be vertical alignment and the like.

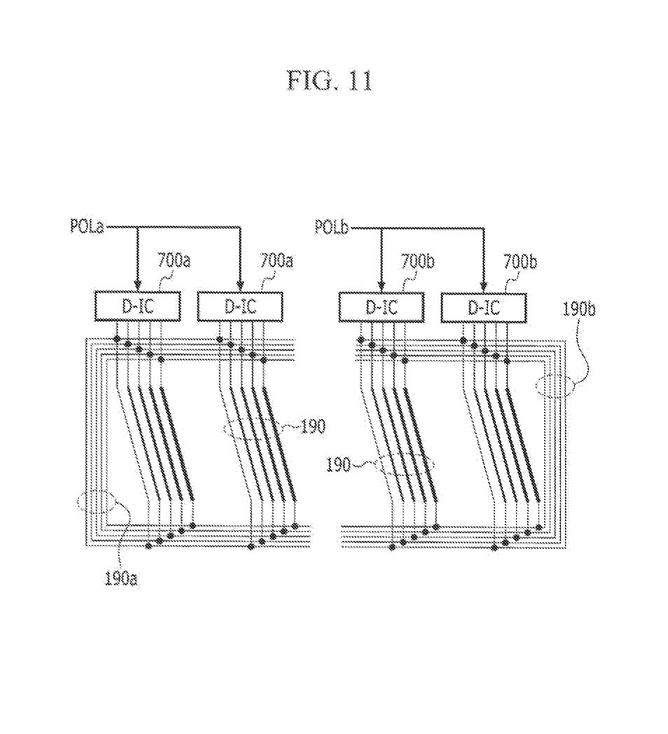

FIG. 9 is a diagram illustrating a phase delay formed according to a position at the liquid crystal fens panel of FIG. 8 according to the exemplary embodiment. The liquid crystal lens panel is implemented by a phase modulation Fresnel zone plate for each unit element.

Referring to FIG. 9, each phase delay of the (n−1)-th zone, the n-th zone, and the (n+1)-th zone of the unit element is changed through four steps. A phase delay in each of the plurality of zones is increased step-by-step from the outer side to the center. The same sub-zone in the plurality of zones causes the same phase delay. A slope of the phase delay for the position in the zone boundary is ideally vertical.

The phase delay formed according to a location at the liquid crystal lens panel 400 can be realized by controlling a driving voltage applied to the first electrode layer 190 of the liquid crystal lens panel 400. In order to prevent deterioration of the liquid crystal lens panel 400, the polarity of the driving voltage applied to the first electrode layer 190 may be periodically inverted.

When the polarity of the driving voltage applied to the first electrode layer 190 is inverted, a large amount of current flows from the power source. This is to promptly charge the liquid crystal layers of the liquid crystal lens panel 400. When an insufficient amount of current is supplied to the liquid crystal lens panel 400 from the power source, the shape of a lens formed in the liquid crystal lens panel 400 is temporarily changed, thereby causing deterioration of display quality of 3D image. However, there is a limit in improving current supply capability and response speed characteristic of the power supply for supplying a sufficient amount of current to the liquid crystal lens panel 400 from the power supply. In particular, a sufficient amount of current cannot be easily supplied to the liquid crystal lens panel 400 from the power supply as the size of the display panel 300 is increased.

Hereinafter, a configuration and a method for supplying a sufficient amount of current to the liquid crystal lens panel 400 will be described.

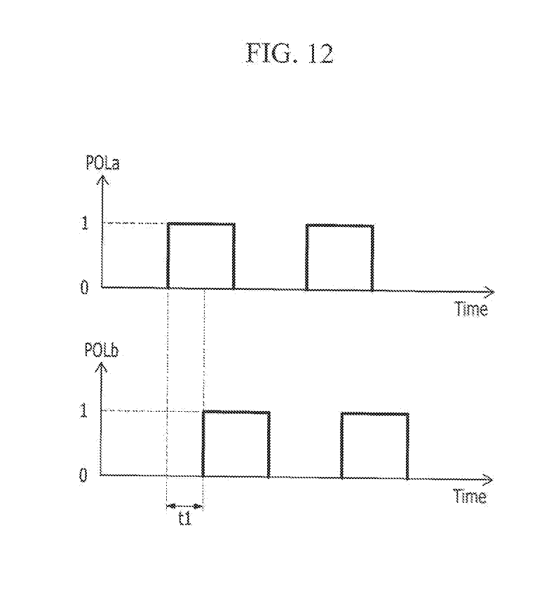

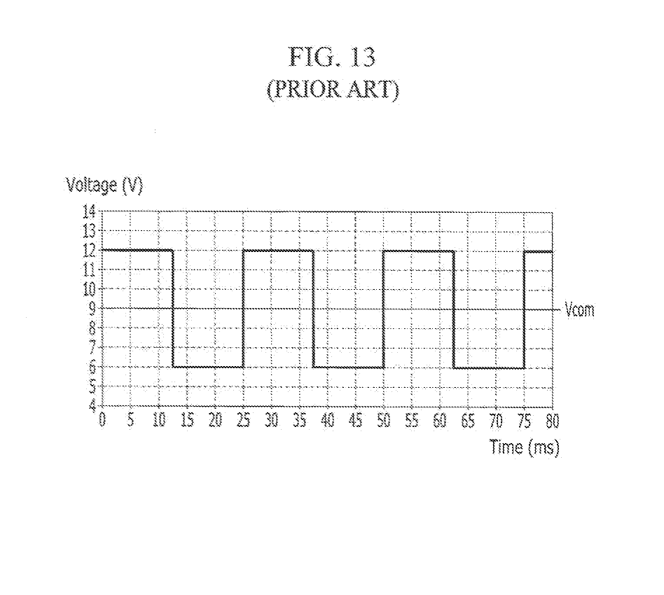

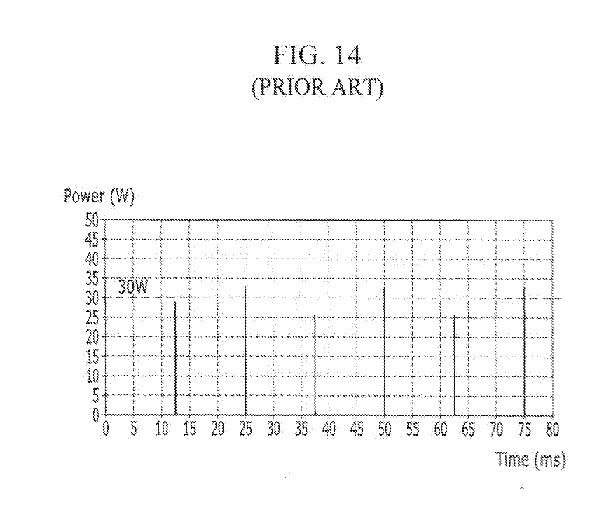

FIG. 10 shows a structure of the liquid crystal lens panel and a structure of an external power supply according to the exemplary embodiment. FIG. 11 shows a connection structure in the liquid crystal lens panel of FIG. 10 in detail. FIG. 12 is a timing diagram illustrating a polarity inversion signal applied to the liquid crystal lens panel of FIG. 10.

Referring to FIG. 10 to FIG. 12, the power supply supplying power to the liquid crystal lens panel 400 includes a DC power source 500, a DC-DC converter 600, a plurality of driving ICs 700a and 700b, and a lens controller 800.

The DC power source 500 is connected to the DC-DC converter 600, and generates a predetermined DC power voltage and supplies the power voltage to the DC-DC converter 600.

The DC-DC converter 600 is connected to the plurality of driving ICs 700a and 700b, and converts the DC power voltage supplied from the DC power source 500 to a predetermined DC voltage and supplies the DC voltage to the plurality of driving ICs 700a and 700b. The DC-DC converter 600 is connected to the lens controller 800, and may be activated by control of the lens controller 800.

The lens controller 800 is connected to the plurality of driving ICs 700a and 700b and the DC-DC converter 600, and controls operation of the plurality of driving ICs 700a and 700b and operation of the DC-DC converter 600 according to an externally received lens control signal CON. The lens control signal CON may be a control signal that instructs operation in the 2D mode and 3D mode. For example, when the lens control signal CON instructs the 2D mode, the lens controller 800 stops operation of the plurality of driving ICs 700a and 700b, and when the lens control signal CON instructs the 3D mode, the lens controller 800 may activate the plurality of driving ICs 700a and 700b. When the lens control signal CON instructs the 2D mode, the lens controller 800 stops operation of the plurality of driving ICs 700a and 700b, and when the lens control signal CON instructs the 3D mode, the lens controller 800 may activate the DC-DC converter 600.

The plurality of driving ICs 700a and 700b include at least one first driving IC 700a and at least one second driving IC 700b.

Among the plurality of driving ICs 700a and 700b, the lens controller 800 applies a first polarity inversion signal POLa to the first driving IC 708a, and applies a second polarity inversion signal POLb to the second driving IC 700b.

The common voltage Vcom is applied to the second electrode layer 290 of the liquid crystal lens panel 400. Although it is not illustrated, the common voltage Vcom may be supplied from the DC-DC converter 600.

The first electrode layer 190 facing the second electrode layer 290 includes a plurality of linear electrodes 193 and 197 extended in an oblique direction, and the plurality of linear electrodes 193 and 197 are connected to one of a first bus line 190a and a second bus line 190b. The plurality of linear electrodes 193 and 197 extended in the oblique direction correspond to a display area of the display panel 300. The first bus line 190a and the second bus line 190b are disposed in a non-display area of the display panel 300. The first bus line 190a and the second bus line 190b are electrically separated. The first bus line 190a and the second bus line 190b may be respectively disposed in two areas divided from the liquid crystal lens panel 400. For example, the first bus line 190a may be disposed in a left-side non-display area of the liquid crystal lens panel 400 and the second bus line 190b may be disposed in a right-side non-display area of the liquid crystal lens penal 400.

Among the plurality of linear electrodes 193 and 197, some are connected to the first driving IC 700a and the remainder are connected to the second driving IC 700b. That is, some of the plurality of linear electrodes 193 and 197 are connected to the first bus line 190a and the remainder are connected to the second bus line 190b. The first bus line 190a and the second bus line 190b may exist one by one in each of the plurality of linear electrodes 193 and 197. Accordingly, the plurality of linear electrodes 193 and 197 may receive different voltages from the driving ICs 700a. and 700b.

The first driving IC 700a inverts a driving voltage applied to the plurality of linear electrodes 193 and 197 with reference to the common voltage Vcom, and then outputs the inverted signal according to the first inversion signal POLa. The second driving IC 700b inverts a driving voltage applied to the plurality of linear electrodes 193 and 197 with reference to the common voltage Vcom, and then outputs the inverted signal according to the second inversion signal POLb. For example, the first driving IC 700a may output a driving voltage that is higher than the common voltage Vcom when the first inversion signal POLa is input as a logic high level voltage (e.g., 1), and may output a driving voltage that is lower than the common voltage Vcom when the first inversion signal POLa is applied as a logic low level voltage (e.g., 0). Likewise, the second driving IC 700b may output a driving voltage that is higher than the common voltage Vcom when the second inversion signal POLb is applied as a logic high level voltage (e.g., 1), and may output a driving voltage that is lower than the common voltage Vcom when the second inversion signal POLb is applied as a logic low level voltage (e.g., 0).

In this case, the lens controller 800 may change the first inversion signal POLa and the second inversion signal POLb with a predetermined time gap t1. For example, the second inversion signal POLb may be delayed by half of the time that the first inversion signal POLa is applied as a logic high level voltage and then output. Alternatively, the second inversion signal POLb may be delayed by a quarter of the time than the first inversion signal POLa is applied and then output. Accordingly, a first driving voltage output from the first driving IC 700a and a second driving voltage output from the second driving IC 700b may be inverted at different times and then output.

As described above, the plurality of linear electrodes 193 and 197 included in the first electrode layer 190 of the liquid crystal lens panel 400 are connected to the first bus line 190a and the second bus line 190b that are electrically separated, and the first driving voltage applied to the first bus line 190a and the second driving voltage applied to the second bus line 190b are inverted at different times, such that a current supplied to the liquid crystal lens panel 400 can be dispersed. Accordingly, a sufficient amount of current is supplied to the liquid crystal lens panel 400 so that deterioration of display quality of a 3D image can be prevented.

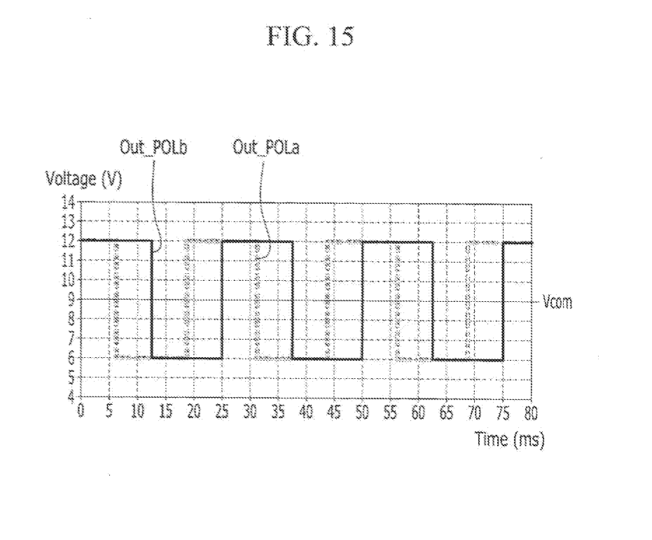

In addition, since the current supplied to the liquid crystal lens panel 400 is dispersed, the peak of power supplied to the DC-DC converter 600 from the DC power source 500 is decreased and thus a power supply burden of the DC power source 500 can be reduced. This will be described with reference to FIG. 13 to FIG. 16.

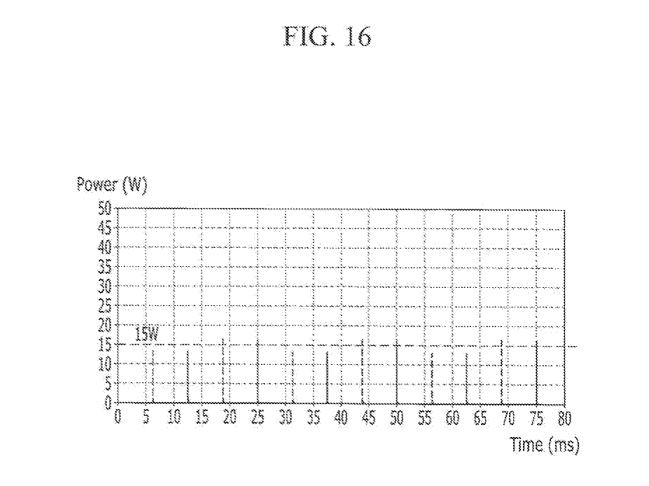

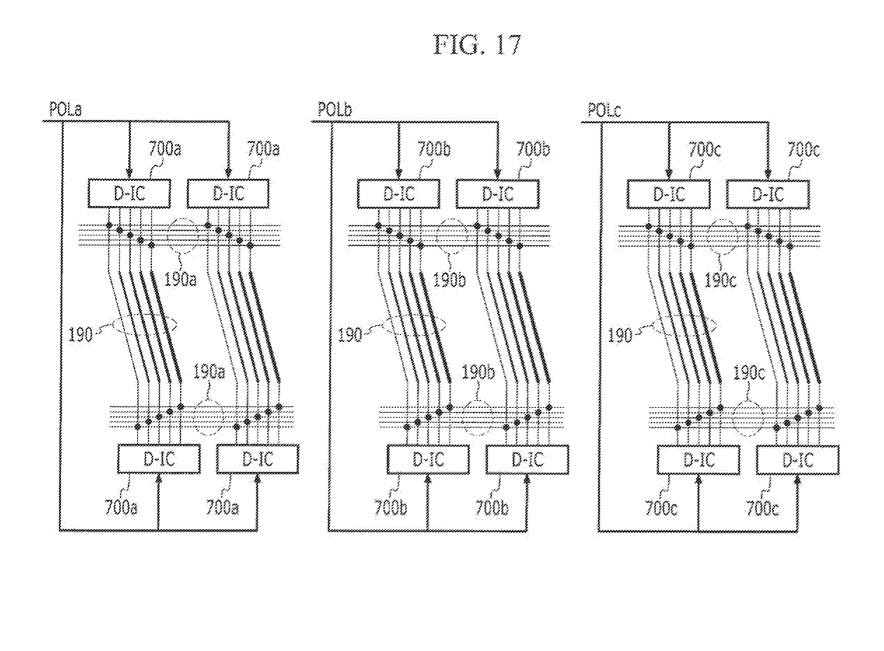

FIG. 13 is a graph illustrating an example of a driving voltage applied to a conventional liquid crystal lens panel. FIG. 14 is a graph illustrating power consumed in the conventional liquid crystal lens panel. FIG. 15 is a graph illustrating an example of a driving voltage applied to an electrode of a liquid crystal lens panel according to the exemplary embodiment. FIG. 16 is a graph illustrating an example of power consumed in the liquid crystal lens panel according to the exemplary embodiment.

In a conventional liquid crystal lens panel, only one bus line exists and all driving ICs simultaneously invert driving voltages and then output them. In such a case, as shown in FIG. 13, when the driving voltage is unitarily changed with reference to the common voltage Vcom, as shown in FIG. 14, power consumed for the change of the driving voltage has a peak at about 30 W.

Meanwhile, as the plurality of linear electrode 193 and 197 included in the first electrode layer 190 of the liquid crystal lens panel 400 are divided into two and then respectively connected to the first bus line 190a and the second bus line 190b that are electrically separated, a first driving voltage Out_POLa applied to the first bus line 190a and a second driving voltage Out_POLb applied to the second bus line 190b are inverted at different times as shown in FIG. 15 so that power consumption thereof has a peak of about 15 W as shown in FIG. 18.

Accordingly, the DC power source 500 does not need to output power of 30 W, and can supply power to the DC-DC converter 600 with an output of about 15 W.

FIG. 17 shows a connection structure of an electrode in a liquid crystal lens panel according to another exemplary embodiment. FIG. 18 is a timing diagram of a polarity inversion signal applied to the liquid crystal lens panel of FIG. 17.

Referring to FIG. 17 and FIG. 18, a plurality of driving ICs 700a, 700b, and 700c connected to a lens controller 800 include a first driving IC 700a, a second driving IC 700b, and a third driving IC 700c. The lens controller 800 applies a first polarity inversion signal POLa to the first driving IC 700a, applies a second polarity inversion signal POLb to the second driving IC 700b, and applies a third polarity inversion signal POLc to the third driving IC 700c.

A first bus line 190a, a second bus line 190b, and a third line 190c are provided in the liquid crystal lens panel 400, and the first driving IC 700a is connected to the first bus line 190a, the second driving IC 700b is connected to the second bus line 190b, and the third driving IC 700c is connected to the third bus line 190c. The first bus line 190a, the second bus line 190b, and the third bus line 190c are electrically separated from each other. Some of a plurality of linear electrodes 193 and 197 included in the first electrode layer 190 are connected to the first driving IC 700a, some of the plurality of linear electrodes 193 and 197 are connected to the second driving IC 700b, and the remainder are connected to the third driving IC 700c. The first driving IC 700a, the second driving IC 700b, and the third driving IC 700c may be respectively connected to lateral ends of the plurality of linear electrodes 193 and 197.

The first driving IC 700a inverts a driving voltage applied to the plurality of linear electrodes 193 and 197 to a common voltage Vcom according to the first inversion signal POLa and then outputs it. The second driving IC 700b inverts a driving voltage applied to the plurality of linear electrodes 193 and 197 to the common voltage Vcom according to the second inversion signal POLb and then outputs it. The third driving IC 700c inverts a driving voltage applied to the plurality of linear electrodes 193 and 197 to the common voltage Vcom according to the third inversion signal POLc and then outputs it.

In this case, the lens controller 800 may change the first inversion signal POLa and the second inversion signal POLb with a first time gap t11 and may change the second inversion signal POLb and the third inversion signal POLc with a second time gap t12. The first time gap t11 and the second time gap t12 may be one third of the time during which the first inversion signal POLa is applied as a logic high level voltage. Alternatively, the first time gap t11 and the second time gap t12 may be randomly changed within a time during which the first inversion signal POLa is applied as a logic high level voltage.

As described, the plurality of linear electrodes 193 and 193 of the liquid crystal lens panel 400 may be divided into three and then connected to three different bus lines 190a, 190b, and 190c, and a current supplied to the liquid crystal lens panel 400 may be dispersed and then supplied. The plurality of linear electrodes 193 and 197 may be divided into three or more and then connected to three or more bus lines.

Meanwhile, in FIG. 11, the first driving IC 700a and the second driving IC 700b are connected to only one end of the plurality of linear electrodes 193 and 197, but as shown in FIG. 17, the first driving IC 700a and the second driving IC 700b of FIG. 11 may be connected to lateral ends of the plurality of linear electrodes 193 and 197.

The detailed description of the accompanying drawings and the disclosure only relate to embodiments, and are used for the purpose of describing the inventive concept but are not used to limit the meanings or a range as described in the claims. Accordingly, those skilled in the art can easily understand that various modifications and equivalent embodiments may be possible. Therefore, a substantial technical protective range will be determined based on a technical idea of the appended claims.

### DESCRIPTION OF SYMBOLS

11: first alignment layer

21: second alignment layer

110: first substrate

190: first electrode layer

210: second substrate

290: second electrode layer

300: display panel

400: liquid crystal lens panel

500: DC power source

600: DC-DC converter

700a, 700b, 700c: driving IC

800: lens controller

What is claimed is:

1. A display device comprising:
a display panel configured to display an image;
a liquid crystal lens panel configured to operate in a 2D mode for recognizing the image as a 2D image and operate in a 3D mode for recognizing the image as a 3D image; and
a power supply configured to supply power to the liquid crystal lens panel,
wherein the liquid crystal lens panel comprises:
a second electrode layer configured to have a common voltage applied;
a first electrode layer facing the second electrode layer and including a plurality of linear electrodes;
a first bus line to which some of the plurality of linear electrodes are connected; and
a second bus line to which remaining linear electrodes are connected, and
wherein the power supply is configured to invert a first driving voltage output to the first bus line and a second driving voltage output to the second bus line at different times and then output them.

2. The display device of claim 1, wherein the power supply comprises:
a first driving IC connected to linear electrodes connected to the first bus line among the plurality of linear electrodes;
a second driving IC connected to linear electrodes connected to the second bus line among the plurality of linear electrodes;
a DC power source configured to generate a DC power voltage;
a DC-DC converter configured to convert the DC power voltage to a predetermined DC voltage and supply the predetermined DC voltage to the first driving IC and the second driving IC; and
a lens controller configured to apply a first polarity inversion signal to the first driving IC and apply a second polarity inversion signal to the second driving IC.

3. The display device of claim 2, wherein
the first driving IC is configured to invert a first driving voltage applied to linear electrodes connected to the first bus line by the first polarity inversion signal and then output it, and
the second driving IC is configured to invert a second driving voltage applied to linear electrodes connected to the second bus line by the second polarity inversion signal and then output it.

4. The display device of claim 3, wherein the second polarity inversion signal is delayed by half the time that the first polarity inversion signal is applied as a logic high level voltage.

5. The delay device of claim 3, wherein the first driving voltage and the second driving voltage are inverted at different times and then output.

6. The display device of claim 2, wherein the first bus line and the second bus line are electrically separated from each other.

7. The display device of claim 2, wherein the lens controller is configured to receive a lens control signal, stop operation of the first driving IC and the second driving IC when the lens control signal instructs the 2D mode, and activate operation of the first driving IC and the second driving IC when the lens control signal instructs the 3D mode.

8. The display device of claim 7, wherein the lens controller is configured to stop operation of the DC-DC converter when the lens control signal instructs the 2D mode and activate the DC-DC converter when the lens control signal instructs the 3D mode.

9. The display device of claim 2, wherein the liquid crystal lens panel further comprises a third bus line to which some of the remaining linear electrodes are connected, and the power supply further comprises a third driving IC connected to linear electrodes that are connected to the third bus line among the plurality of linear electrodes.

10. The display device of claim 9, wherein the lens controller is configured to apply a third polarity inversion signal to the third driving IC, and the third driving IC is configured to convert a third driving voltage applied to linear electrodes connected to the third bus line by the third polarity inversion signal and then output the inverted third driving voltage.

11. The display device of claim 10, wherein the first driving voltage, the second driving voltage, and the third driving voltage are inverted at different times and then output.

12. A liquid crystal lens panel device comprising:
a second electrode layer configured to have a common voltage applied;
a first electrode layer facing the second electrode layer and including a plurality of linear electrodes;
a first bus line to which some of the plurality of linear electrodes are connected;
a second bus line to which remaining linear electrodes are connected;
a first driving IC connected to the linear electrodes connected to the first bus line among the plurality of linear electrodes;
a second driving IC connected to the linear electrodes connected to the second bus line among the plurality of linear electrodes; and
a lens controller configured to apply a first polarity inversion signal to the first driving IC and apply a second polarity inversion signal to the second driving IC.

13. The liquid crystal lens panel device of claim 12, further comprising:
a DC power source configured to generate a DC power voltage; and
a DC-DC converter configured to convert the DC power voltage to a predetermined DC voltage and supply the predetermined DC voltage to the first driving IC and the second driving IC.

14. The liquid crystal lens panel device of claim 13, wherein the first driving IC is configured to invert a first driving voltage applied to the linear electrodes connected to the first bus line by the first polarity inversion signal and then output the inverted first driving voltage, and the second driving IC is configured to invert a second driving voltage applied to the linear electrodes connected to the second bus line by the second polarity inversion signal and then output the inverted second driving voltage.

15. The liquid crystal lens panel device of claim 14, wherein the second polarity inversion signal is delayed by half the time that the first polarity inversion signal is applied as a logic high level voltage and is then output.

16. The liquid crystal lens panel device of claim 14, wherein the first driving voltage and the second driving voltage are inverted at different times and then output.

17. The liquid crystal lens panel device of claim 14, wherein the first bus line and the second bus line are electrically separated from each other.

18. The liquid crystal lens panel device of claim 14, wherein
the liquid crystal lens panel further comprises a third bus line connected to some of the remaining linear electrodes, and
the power supply further comprises a third driving IC connected to the linear electrodes connected to the third bus line among the plurality of linear electrodes.

19. The liquid crystal lens panel device of claim 18, wherein
the lens controller is configured to apply a third polarity inversion signal to the third driving IC, and
the third driving IC is configured to invert a third driving voltage applied to the linear electrodes connected to the third bus line by the third polarity inversion signal and then output the inverted third driving voltage.

20. The liquid crystal lens panel device of claim 19, wherein the first driving voltage, the second driving voltage, and the third driving voltage are inverted at different times and then output.
